(19) United States
(12) Patent Application Publication
(10) Pub. No.: US 2025/0121444 A1
(43) Pub. Date: Apr. 17, 2025

(54) METHOD FOR SETTING UP A GEAR GRINDING PROCESS AND A GEAR GRINDING PROCESS

(71) Applicant: Klingelnberg AG, Zürich (CH)

(72) Inventors: Florian Kienzle, Möglingen (DE); Olaf Vogel, Ettlingen (DE)

(21) Appl. No.: 18/913,186

(22) Filed: Oct. 11, 2024

(30) Foreign Application Priority Data
Oct. 13, 2023 (EP) 23203628.5

(51) Int. Cl. B23F 1/02

(52) U.S. Cl. CPC B23F 1/023

(57) ABSTRACT

A method for setting up a gear grinding process: determining axis movements and/or a geometry of a grinding tool one for multiple grinding strokes by a first quality control loop repeating the steps of grinding, measuring, and correcting for a pre-final target geometry of a gearing, which has an allowance to a final target geometry of the gearing; determining axis movements and/or a geometry of a grinding tool for one for a multiple grinding strokes by second quality control loop by repeating the steps of grinding, measuring, and correcting for the final target geometry of the gearing. The steps of grinding, measuring, and correcting are repeated on one component or on a multiple components until a gearing ground on the respective component or the respective components achieves a predetermined accuracy with respect to the pre-final target geometry and subsequently with respect to the final target geometry.

### CROSS-REFERENCE TO RELATED APPLICATIONS

This application claims the benefit of European patent application 23203628.5 filed 13 Oct. 2023, the disclosure of which is incorporated herein by reference in its entirety.

### TECHNICAL FIELD

The present disclosure relates to a method for setting up a gear grinding process and a gear grinding process.

### BACKGROUND

The machining of gears to be ground usually involves several grinding strokes. For example, one or more so-called roughing strokes are used, which are initially carried out with a larger infeed, followed by at least one so-called finishing stroke, which is carried out with a smaller infeed.

Coarse roughing is used to initially remove material quickly with a larger metal removal rate down to a specified allowance, while final finishing is used to reproduce the specified target geometry of the gearing as precisely as possible on the gearing to be ground with a smaller metal removal rate. In order to achieve short machining times, the aim is to keep the total number of grinding strokes as low as possible.

Between grinding strokes, a change is often made from synchronized machining to counter-rotation machining in order to minimize the time required to reposition the tool between grinding strokes. The change between synchronization and counter-rotation is synonymous with a change in the geometric stroke direction, The final finishing stroke or all finishing strokes are often carried out in the counter-rotation in order to produce a good surface on the tooth flanks. In addition to the infeed and the machining direction, technological variables such as the feed rates and cutting speeds, i.e. the respective speed of the grinding tool, often vary from grinding stroke to grinding stroke.

Investigations by the applicant have shown that the engagement conditions during machining vary from grinding stroke to grinding stroke. Depending on the respective grinding stroke, different displacement forces and excitations act on the grinding tool, which influence the grinding result and thus the shape of the tooth flank produced by the grinding stroke. For example, the roughing strokes and those finishing strokes that may take place before a final finishing stroke can have an influence on the final tooth flank shape produced by the final finishing stroke.

Further investigations by the applicant have shown that the grinding stroke that is carried out immediately before the final grinding stroke, also referred to here as the pre-final grinding stroke, may not produce an allowance required for the final grinding stroke uniformly enough, for example due to a change in the stroke direction before the final grinding stroke. The inaccuracies from the pre-final grinding stroke may not be fully compensated for in the subsequent, final grinding stroke.

In other words, deviations from pre-final roughing or finishing strokes can be transferred to the finally produced actual geometry of the gearing. For example, the displacement of the grinding tool during entry and exit during a pre-final grinding stroke can lead to the deviations resulting from the displacement being measurable in the final flank shape.

Deviations from the desired gear geometry or flank shape are usually corrected in a quality control loop, also known as a “closed loop”. In this process, the finally produced gear geometry is measured and any deviations from the target geometry to be produced are corrected by adjusting the axis movements for grinding the gearing and/or dressing the grinding tool. These adjustments to the axis movements are also called corrections. The closed loop is therefore a quality control loop with the repetitive steps of “grinding”, “measuring” and “correcting”.

The corrections are made in the same way for all grinding strokes. This is due to the fact that the corrections are determined on the basis of the final deviations, i.e. the deviations of the actual geometry from the final target geometry of the gearing to be produced, which are present after the final grinding stroke. The corrected axis movements of the pre-final grinding strokes are thus derived from the corrections of the final grinding stroke. This procedure has the disadvantage that certain negative influences of pre-final grinding strokes on the final flank shape can be reduced, but not removed.

### SUMMARY

Against this background, the present disclosure is based on the technical problem of providing an improved method for setting up a gear grinding process and a gear grinding process which, in particular, enable higher accuracies for the final flank shape and, in particular, a more precise correction.

According to a first aspect, the disclosure relates to a method for setting up a gear grinding process, comprising the method steps of: determining axis movements and/or a geometry of a grinding tool for one grinding stroke or for a plurality of grinding strokes by means of a first quality control loop by repeating the steps of grinding, measuring and correcting for a pre-final target geometry of a gearing, which has an allowance to a final target geometry of the gearing, wherein the steps of grinding, measuring and correcting of the first quality control loop are repeated on one component or on a plurality of components until a gearing ground on the respective component or the respective components has achieved a predetermined accuracy with respect to the pre-final target geometry; determining axis movements and/or a geometry of a grinding tool for a grinding stroke or for several grinding strokes by means of a second quality control loop by repeating the steps of grinding, measuring and correcting for the final target geometry of the gearing, wherein the steps of grinding, measuring and correcting of the second quality control loop are repeated on one component or on a plurality of components until a gearing ground on the respective component or the respective components has achieved a predetermined accuracy with respect to the final target geometry.

The quality control loops according to the disclosure enable a more precise setup of the grinding process, in which a pre-final target geometry of the gearing is already corrected by means of a separate closed loop-namely the first quality control loop. This prevents deviations from roughing strokes, for example, from being transferred to the final flank shape, as these may not be able to be fully corrected with a conventional, single closed loop, as described above.

In other words, according to the disclosure, at least one preliminary stage for the final target geometry is already set up and corrected by means of a separate quality control loop in order to improve the final machining results. In particular, this makes it possible to achieve an allowance required for the final grinding stroke with greater accuracy than would be possible with a conventional, individual quality control loop. By improving one or more pre-final grinding strokes using the first quality control loop, the second quality control loop, which also includes the final grinding stroke, already receives an improved “intermediate product” in the form of gearing with a more accurate allowance.

According to the disclosure, it is therefore also possible to speak of a multi-stage, in particular two-stage, or cascaded closed loop for setting up a grinding process, which corrects and sets up individual grinding strokes or groups of grinding strokes separately by means of assigned quality control loops.

It may be provided that the first quality control loop relates to roughing and the second quality control loop relates to finishing the gearing. In particular, a respective grinding stroke of the first quality control loop can have a larger metal removal rate than a respective grinding stroke of the second quality control loop.

If we are talking about an allowance of the pre-final target geometry compared to a final target geometry, this allowance does not have to be constant over the entire tooth flank. For example, it can be provided that in the center of the tooth flank there is a larger allowance of the pre-final target geometry compared to the final target geometry than in the edge areas of the tooth flank, or vice versa. However, the allowance can be constant for the entire tooth flank. Preferably, the entire tooth flank of the pre-final target geometry has an allowance compared to the final target geometry. However, it is also possible that an individual area, individual areas or individual points of the pre-final target geometry do not have an allowance in relation to the final target geometry.

It may be provided that the axis movements determined by means of the first quality control loop are determined from uncorrected axis movements by assigning corrections to the uncorrected axis movements, wherein the corrections are calculated in the step of correcting of the first quality control loop on the basis of deviations of at least one ground gearing from the pre-final target geometry determined in the step of measuring the first quality control loop.

Uncorrected axis movements are those axis movements that are initially provided by the gear and process design software. They can also be referred to as production data that is transferred to the grinding machine for gear grinding by the gear and process design software. Such software is marketed, for example, by the applicant under the name “Gear Designer”.

The uncorrected production data or uncorrected axis movements are determined by the software for the ideal grinding process. This means that the software assumes a grinding machine that operates without deviations and a tool that operates without deviations. It is understood that the drives, bearings and structures of a grinding machine as well as the tool are subject to tolerances, so that operating the grinding machine with uncorrected production data inevitably leads to deviations of the manufactured actual geometry from the pre-final target geometry.

The first quality control loop therefore adapts the initially uncorrected axis movements transferred to the grinding machine step by step to the grinding machine in question in order to generate the pre-final target geometry of the gearing as precisely as possible on the gearing to be ground by correcting the axis movements.

Depending on the type and severity of the deviations to be corrected, corrections for the axis movements and/or for the geometry of the grinding tool can be used to reduce the measured deviations of the manufactured actual geometry from the pre-final target geometry by means of the first quality control loop.

It may be provided that the geometry of the grinding tool determined by means of the first quality control loop is determined from an uncorrected geometry of the grinding tool by assigning corrections to the uncorrected geometry of the grinding tool, wherein the corrections are calculated in the step of correcting of the first quality control loop on the basis of deviations of at least one ground gearing from the pre-final target geometry determined in the step of measuring of the first quality control loop.

Here too, the first quality control loop adjusts the initially uncorrected production data determined for the theoretically perfect process, in this case the geometry of the grinding tool, for the real process by means of corrections in order to achieve the smallest possible deviation of the ground gearing from the pre-final target geometry. If corrections are specified for the geometry of the grinding tool, these corrections are taken Into account by adapting a dressing process accordingly.

The adjustment of Initially uncorrected production data by means of corrections described above can also be carried out for the second quality control loop, but with reference to the final target geometry.

According to one design of the method, it may be provided that the axis movements determined by means of the second quality control loop are determined from uncorrected axis movements by assigning corrections to the uncorrected axis movements, wherein the corrections are calculated in the step of correcting of the second quality control loop on the basis of deviations of at least one ground gearing from the final target geometry determined in the step of measuring of the second quality control loop.

Alternatively or additionally, it may be provided that the geometry of the grinding tool determined by means of the second quality control loop is determined from an uncorrected geometry of the grinding tool by assigning corrections to the uncorrected geometry of the grinding tool, wherein the corrections are calculated in the step of correcting of the second quality control loop on the basis of deviations of at least one ground gearing from the final target geometry determined in the step of measuring of the second quality control loop.

If the uncorrected production data initially determined by the software, i.e. the uncorrected axis movements and/or the uncorrected geometry of the grinding tool, have been adjusted by corrections of the first quality control loop, this corrected production data can be used as starting values for the second quality control loop. This means that further corrections can be superimposed on the corrections of the first quality control loop by means of the second quality control loop. In other words, the second quality control loop can in this case be regarded as a fine-tuning or adjustment of the corrections of the first quality control loop.

It may therefore be provided that the axis movements and/or the geometry of the grinding tool, which have been determined by means of the first quality control loop, are used as input variables for the second quality control loop, so that a first grinding of the second quality control loop is initially carried out with the axis movements and/or the geometry of the grinding tool, which have been determined by means of the first quality control loop, and these axis movements and/or this geometry of the grinding tool are adapted by repeating the steps of grinding, measuring and correcting of the second quality control loop for the final target geometry of the gearing in order to determine the axis movements and/or the geometry of the grinding tool of the second quality control loop.

Furthermore, it may be provided that the axis movements determined by means of the second quality control loop are determined from the axis movements of the first quality control loop by assigning further corrections to the axis movements or corrections of the first quality control loop, wherein the further corrections are calculated in the step of correcting the second quality control loop on the basis of deviations of at least one ground gearing from the final target geometry determined in the step of measuring the second quality control loop.

Alternatively or additionally, it may be provided that the geometry of the grinding tool determined by means of the second quality control loop is determined from the geometry of the grinding tool of the first quality control loop by assigning further corrections to the geometry of the grinding tool or corrections of the first quality control loop, wherein the further corrections are calculated in the step of correcting the second quality control loop on the basis of deviations of at least one ground gearing from the final target geometry determined in the step of measuring the second quality control loop.

The number of quality control loops required can be defined for a particular grinding process depending on the individual case. For example, the definition of several pre-final target geometries with a quality control loop assigned to a respective pre-final target geometry may be necessary for a grinding process in order to reliably achieve the required tolerances of the gearing.

The method may have further quality control loops for further grinding strokes.

A respective quality control loop can be assigned to each grinding stroke. This means that each individual grinding stroke can be assigned an individual quality control loop intended only for this particular grinding stroke in order to set up the grinding process.

As already discussed, the measured deviations can be corrected via the kinematics of the grinding process and/or via the geometry of the grinding tool. It may therefore be provided that at least one quality control loop has an adjustment of the tool geometry of the grinding tool by dressing. The terms “geometry of the grinding tool” and “tool geometry of the grinding tool” are used synonymously in the present case.

The uncorrected production data can contain uncorrected kinematics for dressing the grinding tool. The corrections may contain corrections for the kinematics of the dressing of the grinding tool. The kinematics of the dressing movement are therefore modified compared to the uncorrected kinematics of the dressing.

According to a second aspect, the disclosure relates to a method comprising the method steps of: grinding a gearing, wherein one or more grinding strokes are performed, wherein axis movements and/or a geometry of a grinding tool are used which have been determined by means of the first quality control loop of the method according to the disclosure for setting up a gear grinding method; further grinding the gearing, wherein a grinding stroke or a plurality of grinding strokes are performed, wherein axis movements and/or a geometry of the grinding tool are used which have been determined by means of the second quality control loop of the method according to the disclosure for setting up a gear grinding method.

It may be provided that corrections of the first quality control loop and/or corrections of the second quality control loop are adapted by carrying out the respective steps of grinding, measuring and correcting for the ground gearing and/or further ground gearings.

After the grinding process, i.e. the gear grinding process, has been set up, the first quality control loop and the second quality control loop can still be carried out, e.g. in order to comply with the specified quality or tolerance requirements during ongoing series production.

Grinding, i.e. gear grinding, can be continuous generating grinding by means of a grinding worm, in particular by means of a dressable grinding worm.

The first quality control loop and/or the second quality control loop can have a determination of axis movements for dressing the grinding worm.

The grinding worm can comprise a first section that has a geometry of the grinding tool according to the first quality control loop, and the grinding worm can have a second section that has a geometry of the grinding tool according to the second quality control loop. Accordingly, one and the same grinding worm can be used for the grinding strokes of both the first quality control loop and the second quality control loop. The section required in each case can be set by shifting.

According to one design, the first section and the second section of the grinding worm can differ only in terms of their geometry according to the first and second quality control loops, but have the same grinding material, i.e. be identical in terms of grain size, grain material, porosity and matrix material. The grinding worm can have a plurality of sections with different geometries for roughing and finishing.

The first section can be set up for roughing to achieve a higher metal removal rate, while the second section can be set up for finishing.

The first section can be set up for roughing, can be set up to achieve a higher metal removal rate and can, for example, have a coarser grain size, while the second section can be set up for finishing and can, for example, have a finer grain size. It is understood that not only the grain size, but also other parameters of a grinding worm, such as the pore size, the grain material and the matrix material, have an influence on the stock removal rate and the suitability of a grinding worm for roughing or finishing.

### BRIEF DESCRIPTION OF THE DRAWINGS

The disclosure is explained in more detail below with reference to drawings illustrating exemplary embodiments, wherein the drawings schematically show in each case:

FIG. 1 shows a first quality control loop of a method according to the disclosure for setting up a gear grinding process;

FIG. 2 shows a second quality control loop of a method according to the disclosure for setting up a gear grinding process;

FIG. 3 shows a grinding worm; and

FIG. 4 shows components in engagement with the grinding wheel from FIG. 3.

### DETAILED DESCRIPTION OF THE DRAWINGS

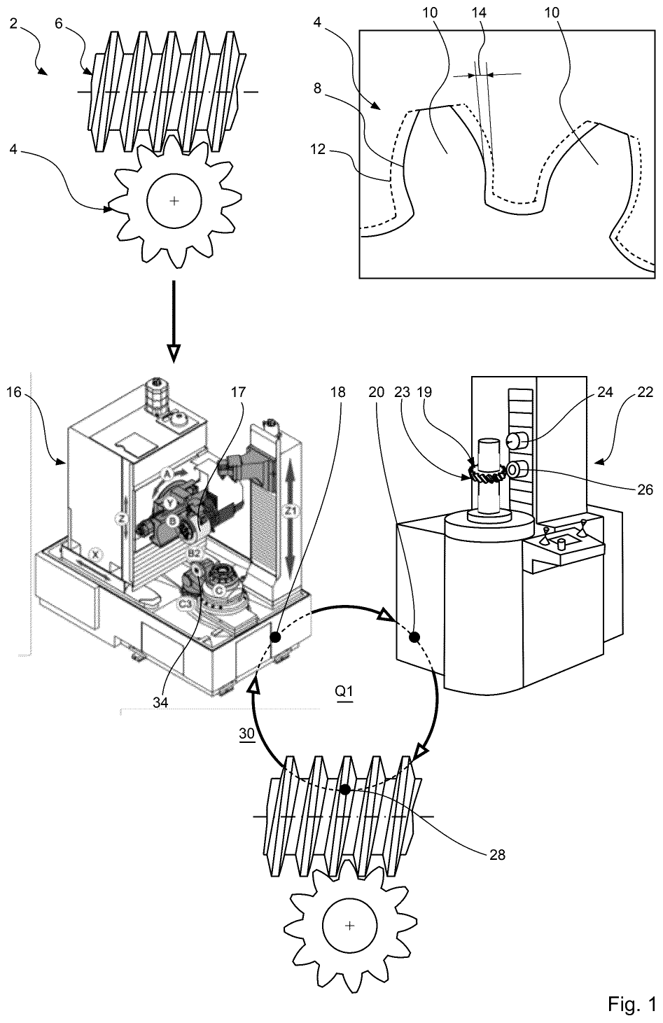

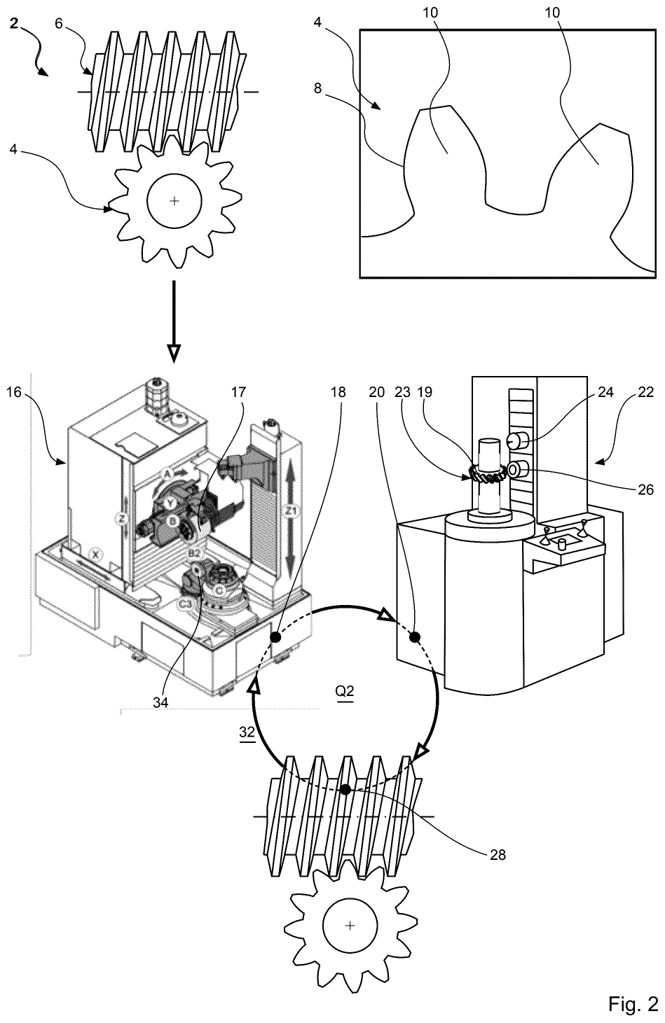

First, in a preparatory method step 2, a gearing 4, a grinding tool 6 for continuous generating grinding of the gearing 4 and axis movements, i.e. process kinematics required to produce the gearing 4 by means of the grinding tool 6, are designed. The design can be software-based, for example using the “Gear Designer” software distributed by the applicant (FIG. 1). The results of the design can be referred to overall as production data.

The component to be ground, on which the gearing 4 is to be produced, can for example be a spur gear with straight teeth or a helical gear with helical teeth, which is to be produced by generating grinding using a grinding worm.

The gearing 4 designed using the software has a final target geometry 8. The final target geometry 8 is the final geometry of the gearing 4 that is ultimately to be produced within a specified tolerance range using the gear grinding process according to the disclosure.

The final target geometry 8 is shown as a solid line in a sectional enlargement for two teeth 10 of the gearing 4 as an example.

Furthermore, the gearing 4 designed using the software has a pre-final target geometry 12, which has an allowance 14 to the final target geometry 8. The pre-final target geometry 12 is shown as a dashed line in the enlarged section as an example. In the present case, the pre-final target geometry 12 represents an intermediate result of the gear grinding process comprising a plurality of grinding strokes, which is to be achieved after one or more roughing strokes and before the execution of finishing strokes.

According to alternative exemplary embodiments, it can be provided that there is no allowance in the tooth root and the tooth root is not ground. In this case, a pre-gearing can be provided, optionally with a protuberance, in order to avoid a grinding notch in the tooth root.

The production data of the design according to method step 2 is now transferred to a grinding machine 16. The production data includes uncorrected axis movements for the controlled axes X, Y, Z, A, B and C of the grinding machine 16.

In addition, the production data comprise an uncorrected geometry for the grinding tool 17 to be used, so that initially a gearing is produced on a first component 19 by means of the uncorrected axis movements and the uncorrected geometry of the grinding tool. This grinding of a gearing 23 of a first component 19 forms the first method step 18 “Grinding” of a first quality control loop Q1 of the method according to the disclosure for setting up the gearing grinding method.

After the gearing on the first component 19 has been ground, this component 19 is transferred to the first quality control loop Q1 in a second method step 20 “Measuring”. For this purpose, the gearing 23 of the component 19 is measured on a coordinate measuring machine 22 using a tactile measuring probe 24 or an optical measuring device 26.

Based on the measurement, deviations of the actual geometry of the ground gearing from the pre-final target geometry 12 to be produced first are determined and, in a third method step 28 “correction” of the first quality control loop Q1, corrections 30 for the axis movements and/or the geometry of the grinding tool are determined and transferred to the grinding machine 16.

The correction can be carried out in a software-based manner, e.g. using the “Gear Corrector” software, which is distributed by the applicant.

If, for example, only a correction of the axis movements is required due to the measured deviations of the manufactured actual geometry from the pre-final target geometry to be manufactured, the first quality control loop Q1 is now carried out again, starting with the “grinding” method step, which is now carried out using the corrected axis movements. According to alternative exemplary embodiments, it may be provided that the corrections also include a correction for the geometry of the grinding tool 17, if the measured deviations require this. In this case, the grinding tool 17 can be dressed accordingly before regrinding.

The method steps of “grinding” 18, “measuring” 20 and “correcting” 28 are now repeated on one or more components until a gearing 23 ground on the respective component 19 or the respective components 19 has achieved a predetermined accuracy with respect to the pre-final target geometry or complies with predetermined tolerances. If those corrections have been determined for which the specified accuracy or the required tolerances of the gearing are maintained, the first quality control loop Q1 of the method for setting up the gear grinding method is completed and the corrections for the roughing strokes are known.

In a next method step, the procedure described above is repeated for a second quality control loop Q2, wherein the second quality control loop Q2 is used to optimize finishing strokes of the gear grinding process to be set up, taking into account the final target geometry 8.

For this purpose, axis movements and/or a geometry of a grinding tool are therefore again determined for a finishing stroke or for several finishing strokes, namely by repeating the steps of “grinding”, “measuring” and “correcting” for the final target geometry 8 of the gearing 4, wherein the steps of “grinding”, “measuring” and “correcting” of the second quality control loop Q2 are repeated on one component or on several components until a gearing 23 ground on the respective component 19 or the respective components 19 has achieved a predetermined accuracy with respect to the final target geometry.

In the present example, the axis movements and/or the geometry of the grinding tool, which have been determined by means of the first quality control loop Q1, serve as input variables for the second quality control loop Q2, so that a first grinding of the second quality control loop Q2 is initially carried out with the axis movements and/or the geometry of the grinding tool, which have been determined by means of the first quality control loop Q1, and these axis movements and/or this geometry of the grinding tool are adapted for the final target geometry of the gearing by repeating the steps “grinding”, “measuring” and correcting of the second quality control loop in order to determine the axis movements and/or the geometry of the grinding tool of the second quality control loop Q2.

Further corrections 32 are therefore superimposed on the corrections 30 of the first quality control loop by means of the second quality control loop in order to be able to produce the required final target geometry 8 of the gearing 4 as precisely as possible by means of the finishing strokes.

In order to correct the geometry of the grinding tool, the grinding tool 17 can be dressed by means of the grinding machine 16, wherein the grinding machine 16 comprises a dresser 34 and controlled axes for dressing, which perform corrected axial movements for dressing, namely the axes B2 and C3 of the dresser, as well as the corresponding axes of the grinding machine 16 already mentioned above, which are provided for controlling the movements of the grinding tool 17, namely the axes X, Y, Z, A, B.

According to alternative exemplary embodiments, it may be provided that the quality control loops Q1 and Q2 are independent of each other and no corrections are transferred from the first quality control loop Q1 to the second quality control loop Q2. In this case, both quality control loops Q1 and Q2 start with the uncorrected production data of the design and corrections are determined independently of each other.

After the first quality control loop Q1 and the second quality control loop have been completed and the corrections 30 for roughing and the corrections 32 for finishing have been determined, series production can be carried out using the gear grinding process that has been set up.

A method is then carried out on the grinding machine 16, with the method steps of: grinding of a gearing, wherein one grinding stroke or several grinding strokes are carried out, wherein axis movements and/or a geometry of a grinding tool are used, which have been determined by means of the first quality control loop Q1; further grinding of the gearing, wherein one grinding stroke or several grinding strokes are carried out, wherein axis movements and/or a geometry of the grinding tool are used, which have been determined by means of the second quality control loop Q2. The grinding is a continuous generating grinding by means of the dressable grinding worm 17.

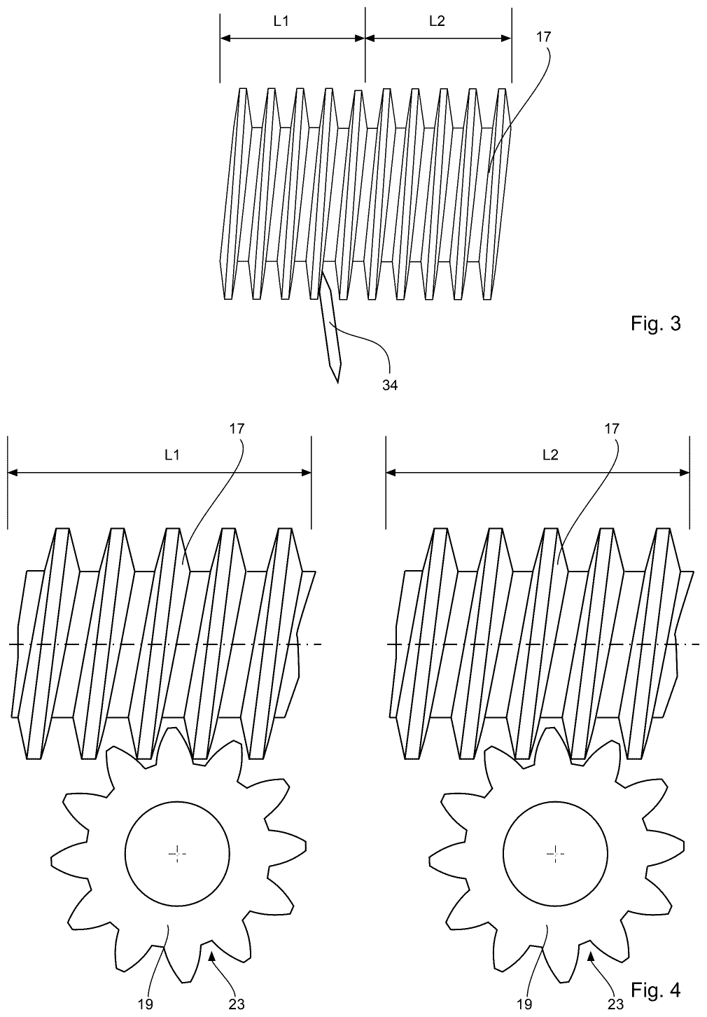

As shown by way of example in FIGS. 3 and 4, it may be provided that the grinding worm 17 has a first section L1 which has a geometry of the grinding tool according to the first quality control loop Q1, and that the grinding worm 17 has a second section L2 which has a geometry of the grinding tool 17 according to the second quality control loop Q1.

The first section L1 can be used for roughing the gearing 23 of the component 19 (FIG. 4). The second section L2 can be used for finishing the gearing 23 of the component 19. The list of reference signs is the subject matter of the disclosure.

When corrections are referred to in this text, they may, for example, Involve changed positions and/or changed travel paths and/or changed speeds for the machine axes X, Y, Z, A, B, C B2, C3. For example, it may be provided that a position of the X-axis, which was specified as constant during grinding according to the uncorrected production data, can now be moved during grinding, or a curve can be moved using Z and X instead of a straight line. Similarly, the corrections for one or more grinding strokes can, for example, have an adjusted infeed, an adjusted cutting speed, an adjusted grinding tool or workpiece rotation, a changed stroke speed or the like. A shift ratio can also be changed.

With regard to the geometry of the grinding tool, the corrections can have, for example, modified values for a pressure angle, the pitch, a lead angle and the like, which are generated by means of corrected dressing movements on the grinding tool.

1. A method for setting up a gear grinding process, the method including the following steps:
determining axis movements and/or a geometry of a grinding tool for one grinding stroke or for a plurality of grinding strokes by a first quality control loop by repeating the steps of grinding, measuring and correcting for a pre-final target geometry of a gearing, which has an allowance to a final target geometry of the gearing, wherein the steps of grinding, measuring and correcting of the first quality control loop are repeated on one component or on a plurality of components until a gearing ground on the respective component or the respective components has achieved a predetermined accuracy with respect to the pre-final target geometry; and
determining axis movements and/or a geometry of a grinding tool for one grinding stroke or for a plurality of grinding strokes by a second quality control loop by repeating the steps of grinding, measuring and correcting for the final target geometry of the gearing, wherein the steps of grinding, measuring and correcting of the second quality control loop are repeated on one component or on a plurality of components until a geometry of the gearing which is desired on the respective component is determined, measuring and correcting of the second quality control loop are repeated on one component or on a plurality of components until a gearing ground on the respective component or the respective components has achieved a predetermined accuracy with respect to the final target geometry.

2. The method according to claim 1, wherein
the axis movements determined by the first quality control loop are determined from uncorrected axis movements by assigning corrections to the uncorrected axis movements, wherein the corrections are calculated in the step of correcting of the first quality control loop on the basis of deviations of at least one ground gearing from the pre-final target geometry determined in the step of measuring of the first quality control loop and/or
the geometry of the grinding tool determined by the first quality control loop is determined from an uncorrected geometry of the grinding tool by assigning corrections to the uncorrected geometry of the grinding tool, wherein the corrections are calculated in the step of correcting of the first quality control loop on the basis of deviations of at least one ground gearing from the pre-final target geometry determined in the step of measuring of the first quality control loop.

3. The method according to claim 1, wherein
the axis movements determined by the second quality control loop are determined from uncorrected axis movements by assigning corrections to the uncorrected axis movements, wherein the corrections are calculated in the step of correcting of the second quality control loop on the basis of deviations of at least one ground gearing from the final target geometry determined in the step of measuring of the second quality control loop and/or
the geometry of the grinding tool determined by the second quality control loop is determined from an uncorrected geometry of the grinding tool by assigning corrections to the uncorrected geometry of the grinding tool, wherein the corrections are calculated in the step of correcting of the second quality control loop on the basis of deviations of at least one ground gearing from the final target geometry determined in the step of measuring of the second quality control loop.

4. The method according to claim l, wherein the axis movements and/or the geometry of the grinding tool, which have been determined by the first quality control loop, are used as input variables for the second quality control loop, so that a first grinding of the second quality control loop is initially carried out with the axis movements and/or the geometry of the grinding tool, which have been determined by the first quality control loop, and these axis movements and/or this geometry of the grinding tool are adapted by repeating the steps of grinding, measuring and correcting of the second quality control loop for the final target geometry of the gearing in order to determine the axis movements and/or the geometry of the grinding tool of the second quality control loop.

5. The method according to claim 2, wherein
the axis movements determined by the second quality control loop are determined from the axis movements of the first quality control loop by assigning further corrections to the axis movements or corrections of the first quality control loop, wherein the further corrections are calculated in the step of correcting of the second quality control loop on the basis of deviations of at least one ground gearing from the final target geometry determined in the step of measuring of the second quality control loop and/or
the geometry of the grinding tool determined by the second quality control loop is determined from the geometry of the grinding tool of the first quality control loop by assigning further corrections to the geometry of the grinding tool or corrections of the first quality control loop, wherein the further corrections are calculated in the step of correcting of the second quality control loop on the basis of deviations of at least one ground gearing from the final target geometry (8) determined in the step of measuring of the second quality control loop.

6. The method according to claim 1, wherein further quality control loops are provided for further grinding strokes or a respective quality control loop is assigned to each grinding stroke.

7. The method according to claim 1, wherein at least one quality control loop has an adaptation of the tool geometry by dressing.

8. A method including the following steps:
grinding a gearing, wherein one or more grinding strokes are performed, wherein axis movements and/or a geometry of a grinding tool are used which have been determined by the first quality control loop according to claim 2, and
further grinding the gearing, wherein a grinding stroke or a plurality of grinding strokes are performed, wherein axis movements and/or a geometry of the grinding tool are used which have been determined by the second quality control loop.

9. The method according to claim 8, wherein corrections of the first quality control loop and/or corrections of the second quality control loop are adapted by carrying out the respective steps of grinding, measuring and correcting for the ground gearing and/or further ground gearings.

10. The method according to claim 1, wherein
the grinding is a continuous generating grinding by a grinding worm.

11. The method according to claim 10, wherein
the first quality control loop and/or the second quality control loop have a determination of axis movements for dressing the grinding worm.

12. The method according to claim 10, wherein
the grinding worm comprises a first section that has a geometry of the grinding tool according to the first quality control loop, and in that the grinding worm comprises a second section that has a geometry of the grinding tool according to the second quality control loop.
